(19) United States
(12) Patent Application Publication
(10) Pub. No.: US 2026/0089295 A1
(43) Pub. Date: Mar. 26, 2026

(54) PROJECTOR AND COLOR WHEEL MODULE THEREOF

(71) Applicant: Qisda Corporation, Taoyuan City (TW)

(72) Inventors: Hsin-Jung YEH, Taoyuan City (TW); Chun-Ming SHEN, Taoyuan City (TW); Sheng-Wen HU, Taoyuan City (TW); Hsin-Liang CHEN, Taoyuan City (TW)

(73) Assignee: Qisda Corporation, Taoyuan City (TW)

(21) Appl. No.: 19/276,167

(22) Filed: Jul. 22, 2025

(30) Foreign Application Priority Data
Sep. 20, 2024 (CN) 202411317702.2

(51) Int. Cl. H04N 9/31; G03B 21/16

(52) U.S. Cl. CPC H04N 9/3114; G03B 21/16; H04N 9/3158

(57) ABSTRACT

A projector and a color wheel module thereof are provided. The color wheel module includes a fixing member, a base, a moving part, a locking member and a vibration-absorbing pad. The fixing member includes an axial hole and a through hole. The moving part is arranged on the base and rotates around an axial direction, and the axial direction passes through the axial hole. The locking member passes through the through hole, one end of the locking member is fixed to the base, and the base is fixed to the fixing member through the locking member. The vibration-absorbing pad is arranged on one side of the fixing member corresponding to the base and in the through hole, and the vibration-absorbing pad separates the locking member from the corresponding fixing member and separates the fixing member from the corresponding base.

This application claims the benefit of People’s Republic of China application Serial No. 202411317702.2, filed September 20, 2024, the subject matter of which is incorporated herein by reference.

### BACKGROUND OF THE INVENTION

### Field of the Invention

The invention relates in general to a projector, and more particularly to a projector and a color wheel module thereof.

### Description of the Related Art

Currently, projectors mainly have two types: liquid crystal display (LCD) and digital light processing (DLP). DLP projectors use digital micro-mirror device (DMD) reflection technology and a color wheel module for the separation and processing of colors.

Since the color wheel is a high-speed rotating moving part, it is easy to vibrate and transmit noise/energy into the optical machine module. Therefore, it is necessary to improve the vibration of the color wheel.

### SUMMARY OF THE INVENTION

The present invention relates to a projector and a color wheel module thereof, which can reduce the vibration of the color wheel module through a vibration-absorbing structure of a locking point.

According to one aspect of the present invention, a color wheel module is provided. The color wheel module includes a fixing member, a base, a moving part, a locking member and a vibration-absorbing pad. The fixing member includes an axial hole and a through hole. The moving part is arranged on the base and rotates around an axial direction, and the axial direction passes through the axial hole. The locking member passes through the through hole, one end of the locking member is fixed to the base, and the base is fixed to the fixing member through the locking member. The vibration-absorbing pad is arranged on one side of the fixing member corresponding to the base and in the through hole, and the vibration-absorbing pad separates the locking member from the corresponding fixing member and separates the fixing member from the corresponding base.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 is a three-dimensional diagram of a color wheel module according to an embodiment of the present invention.

FIGS. 2A and 2B are exploded schematic diagrams of the color wheel module of FIG. 1 at different viewing angles.

FIG. 3 is a schematic cross-sectional view of the color wheel module of FIG. 1 along line A-A.

FIG. 4 is a schematic cross-sectional view of the color wheel module of FIG. 1 along line B-B.

FIG. 5 is a three-dimensional view of a color wheel module according to another embodiment of the present invention.

FIGS. 6A and 6B are exploded schematic diagrams of the color wheel module of FIG. 5 at different viewing angles.

FIG. 7 is a schematic cross-sectional view of the color wheel module of FIG. 5 along line A-A.

FIG. 8 is a schematic cross-sectional view of the color wheel module of FIG. 5 along line B-B.

### DETAILED DESCRIPTION OF THE INVENTION

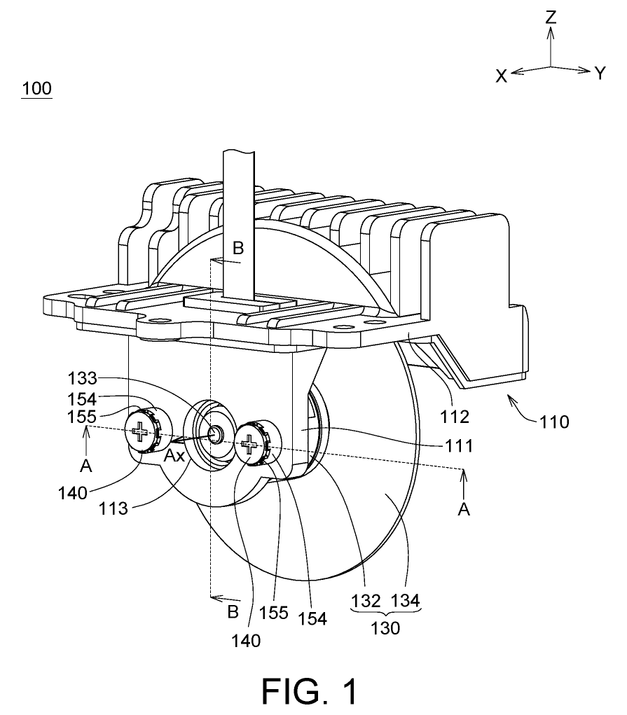

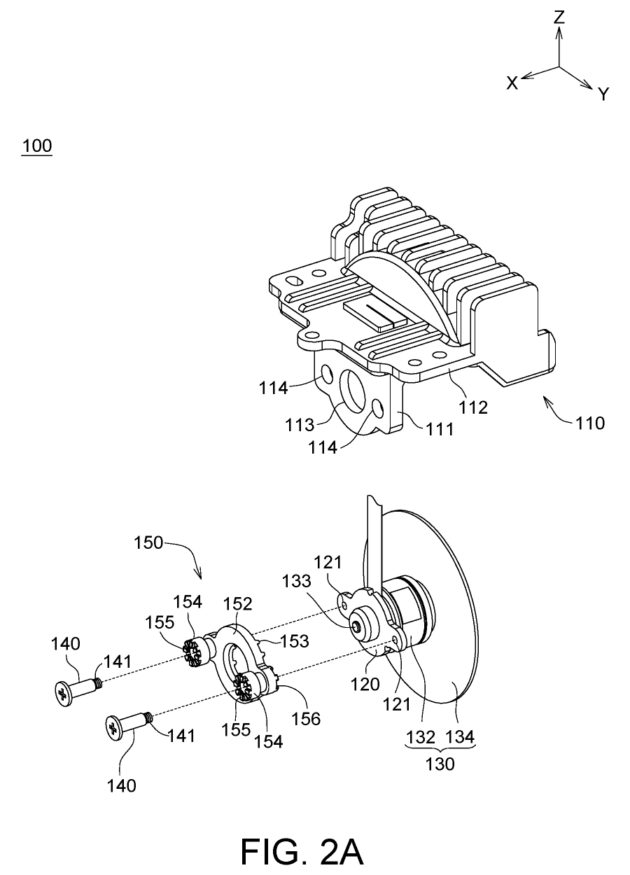

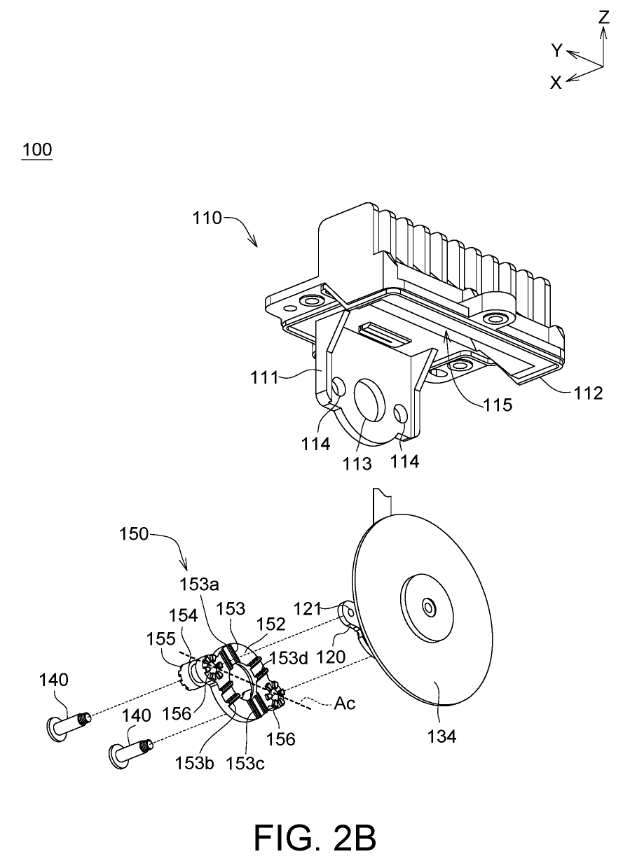

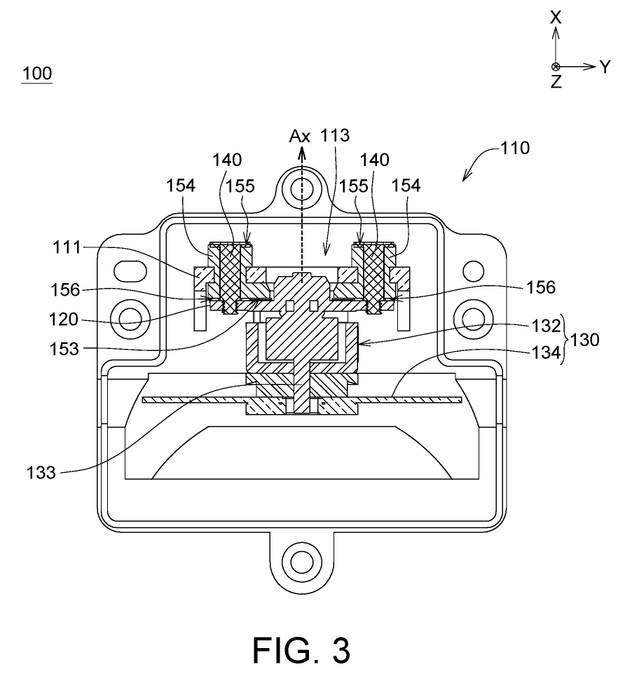

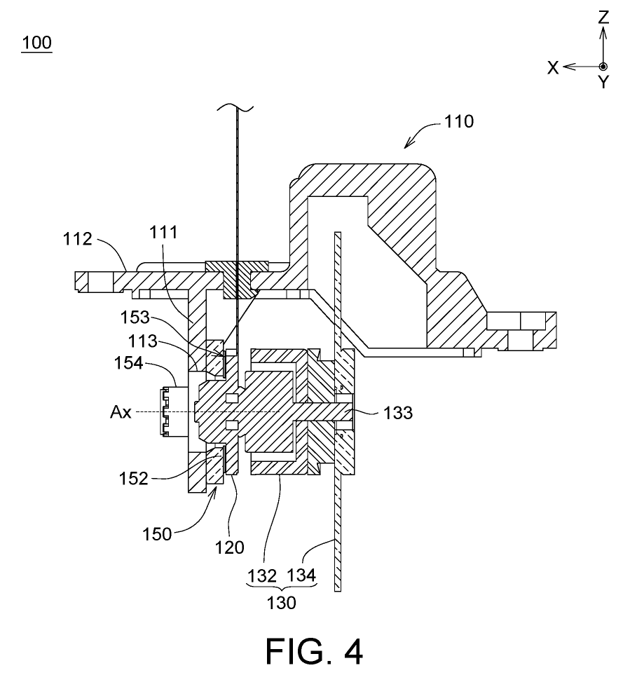

Referring to FIGS. 1 to 4, FIG. 1 is a three-dimensional view of a color wheel module 100 according to an embodiment of the present invention, and FIGS. 2A and 2B are exploded schematic diagrams of the color wheel module 100 of FIG. 1 at different viewing angles. FIG. 3 is a schematic cross-sectional view of the color wheel module 100 of FIG. 1 along the line A-A, and FIG. 4 is a schematic cross-sectional view of the color wheel module 100 of FIG. 1 along the line B-B.

Although the accompanying drawings do not show the detailed internal structure of the projector, it is known to those skilled in the art that the color wheel module 100 of FIG. 1 can be used in a digital micro-mirror device (DMD) projection system, in which a white light emitted by the light source is focused on the color wheel 134 through the focusing lens. The color wheel 134 is mainly composed of red, green, blue and other color filters. It can also have more color filters according to actual needs. The color wheel 134 is driven by a high-speed motor to separate the white light into multiple color lights and then the lights of specific colors are projected onto the surface of the DMD. The DMD is composed of small mirrors corresponding to the number of pixels, which rotate according to the control of the video signal. When the small mirrors rotate to reflect the color lights passing through the projector lens, it means the pixel is turned on. When the small mirrors rotate to reflect the color lights deviating from the projector lens, it means the pixel is turned off. A ratio of the opening and closing time of one pixel indicates the brightness of the pixel. When a red image is projected on the DMD surface, the mirrors on the DMD rotate to open or close according to the red video signal, so that the reflected red image to be displayed is projected onto the display screen through the projector lens. The same is done for other video signals (e.g., green and blue light images). Therefore, the human visual system can see a full-color image by receiving the projected red, green, and blue light images.

Referring to FIGS. 1, 2A and 2B, the color wheel module 100 includes a fixing member 110, a base 120, a moving part 130, a locking member 140 (two locking members 140 are illustrated as an example) and a vibration-absorbing pad 150. The fixing member 110 is, for example, a metal member, which is cast in an integral manner. The color wheel module 100 can be fixed in the body of the projector, for example, on the optical machine, through the fixing member 110. The fixing member 110 may also be referred to as a bracket of the color wheel 134, which includes a first bracket 111 and a second bracket 112 perpendicular to the first bracket 111. The first bracket 111 has an axial hole 113 and two through holes 114. The axial hole 113 is aligned with the axial direction Ax (see FIG. 4) of the moving part 130. The through holes 114 are used to assemble the moving part 130 on the fixed member 110. The second bracket 112 has an opening 115 (see FIG. 2B). The opening 115 of the second bracket 112 is formed by, for example, a stamping process, and a light-absorbing coating, such as a black coating, may be provided on its surface of the second bracket 112 to absorb interfering light.

The moving part 130 may include a rotating component 132, a rotating shaft 133 and a color wheel 134. The rotating component 132 is, for example, a motor. The center of the color wheel 134 is connected to the motor through the rotating shaft 133. When the motor drives the rotating shaft 133 to rotate, the color wheel 134 also rotates accordingly. In one embodiment, the moving part 130 is disposed on the base 120 and rotates around an axial direction Ax of the rotating shaft 133, and the axial direction Ax passes through the center of the axial hole 113 of the fixing member 110.

One end of the locking member 140 (see FIG. 2A) can pass through the through hole 114 and be fixed to the base 120. The locking member 140 can be used to fix the base 120 to the fixing member 110. In other words, the base 120 is fixed to the first bracket 111. In addition, the locking member 140 and the corresponding fixing member 110 may be separated by the vibration-absorbing pad 150. That is, a portion of the vibration-absorbing pad 150 (i.e., the covering portion 154, see FIGS. 2A and 2B) can separate the locking member 140 from the first bracket 111. In addition, the vibration-absorbing pad 150 may separate the fixing member 110 from the corresponding base 120, that is, a portion of the vibration-absorbing pad 150 (i.e., the annular portion 152, see FIG. 2A and FIG. 2B) can separate the first bracket 111 from the corresponding base 120.

In one embodiment, the locking member 140 is, for example, a screw having a thread 141 at one end thereof, and the thread 141 of the locking member 140 can be correspondingly locked in the screw hole 121 of the base 120, so that the base 120 is fixed to the fixed member 110. However, when the color wheel 134 and other moving parts 130 rotate at high speed, the vibration of the color wheel 134 will be transmitted to the fixing part 110 through the locking part 140. In one embodiment, the vibration of the color wheel module 100 can be reduced by the vibration-absorbing pad 150 at the locking member 140.

Referring to FIGS. 3and4, the vibration-absorbing pad 150 is disposed on one side of the fixing member 110 corresponding to the base 120 and in the through hole 114. The vibration-absorbing pad 150 includes an annular portion 152 and a covering portion 154. The annular portion 152 is correspondingly located around the axial hole 113 (see FIG. 4). The annular portion 152 may include a protruding member 153. The protruding member 153 and the fixing member 110 overlap and interfere with each other in the axial direction Ax. In addition, the covering portion 154 is correspondingly located in the through hole 114 (i.e., the covering portion 154 can be sleeved in the through hole 114), and the covering portion 154 surrounds the periphery of the locking member 140 (see FIG. 3). The two ends of the covering portion 154 may respectively have a first protruding member 155 and a second protruding member 156. The first protruding member 155 and the base 120 overlap and interfere with each other in the axial direction Ax, and the second protruding member 156 and the locking member 140 overlap and interfere with each other in the axial direction Ax.

In one embodiment, the material of the vibration-absorbing pad 150 is, for example, foam or rubber. The vibration-absorbing pad 150 is an integrally formed buffer structure for absorbing the vibration energy transmitted from the color wheel 134 to the fixing member 110. In addition, the number of the through holes 114 is, for example, two. The two through holes 114 are located at two opposite sides of the axial hole 113, and the two through holes 114 are located on a center line Ac passing through the axial hole 113. That is to say, the center line Ac connected between the two through holes 114 passes through the center of the axial hole 113. In addition, the number of the locking members 140 is, for example, two. Since the locking members 140 are symmetrically distributed relative to the Z axis, when the vibration energy transmitted from the color wheel 134 to the fixing member 110 vibrates relative to the Z axis, the vibration energy and shaking from the color wheel 134 can be absorbed by the vibration-absorbing pad 150 (i.e., the covering portion 154) wrapped around the locking members 140 to achieve a vibration-absorbing effect. Furthermore, the size of the projector is getting smaller and smaller. In order to install the color wheel module 100 in a small and lightweight projector, the size of the color wheel module 100 is also getting smaller and smaller, and the number of the locking members 140 is reduced to two, the vibration-absorbing pad 150 needs to be installed in a limited space of the projector to achieve the effect of vibration absorption and noise reduction.

In one embodiment, the protruding member 153, the first protruding member 155 and the second protruding member 156 are, for example, ribs, which are respectively disposed on the side surface of the annular portion 152 corresponding to the base 120 and the two ends of the covering portion 154 corresponding to the side surfaces of the locking member 140 and the base 120. As shown in FIG. 2B, the protruding members 153 are symmetrically arranged structures and are distributed in strips, dots, or other geometric shapes, but the present invention is not limited thereto. The protruding members 153 are distributed on opposite sides of the center line Ac. For example, the protruding members 153 are distributed orthogonally, mirror-distributed, or axisymmetrically distributed with respect to the center line Ac. The number of the protruding members 153 is not limited. Orthogonal distribution means that two protruding members 153 are located on the perpendicular bisector of the center line Ac, mirror distribution means that two, four or six protruding members 153 are mirror-distributed on the annular portion 152, and axisymmetric distribution means that two protruding members 153 are symmetrical with respect to the axial direction Ax of the axial hole 113. Therefore, when the vibration energy transmitted from the color wheel 134 to the fixing member 110 vibrates relative to the center line Ac, the protruding members 153 can absorb the vibration energy and shaking from the color wheel 134 to achieve a vibration-absorbing effect.

Referring to FIG. 2B, the protrusion members 153 may include a first protrusion 153a, a second protrusion 153b, a third protrusion 153c and a fourth protrusion 153d, the number of protrusions is not limited. The connection line between the first protrusion 153a and the second protrusion 153b passes through the center of the axial hole 113, and the connection line between the third protrusion 153c and the fourth protrusion 153d passes through the center of the axial hole 113. In one embodiment, the first protrusion 153a, the second protrusion 153b, the third protrusion 153c and the fourth protrusion 153d are distributed in the annular portion 152 in a mirror-imaged manner relative to the center line Ac. In addition, the first protrusion 153a and the third protrusion 153c are distributed in an axisymmetric manner relative to the center line Ac, and the second protrusion 153b and the fourth protrusion 153d are distributed in an axisymmetric manner relative to the center line Ac. In addition, in another embodiment not shown, the protruding members 153 may be an asymmetric structure relative to the center line Ac, for example, the first protruding member 153a and the second protruding member 153b have different shapes or are asymmetrically positioned. The third protrusion 153c and the fourth protrusion 153d have different shapes or are asymmetrically positioned, so that the first protrusion 153a and the second protrusion 153b are distributed in a non-mirror-imaged manner relative to the center line Ac, and the third protrusion 153c and the fourth protrusion 153d are distributed in a non-mirror-imaged manner relative to the center line Ac.

As shown in FIG. 4, in the axial direction Ax, the area where the annular portion 152 is perpendicularly projected onto the fixing member 110 (that is, the first bracket 111) and the area where the base 120 is perpendicularly projected onto the fixing member 110 (that is, the first bracket 111) at least partially overlap. In addition, as shown in FIG. 3, the covering portion 154 is, for example, a hollow columnar structure, and the locking member 140 can pass through the hollow columnar structure and be fixed on the base 120. In addition, the first protruding member 155 and the locking member 140 overlap and interfere with each other in the axial direction Ax, and the second protruding member 156 and the base 120 overlap and interfere with each other in the axial direction Ax.

The shape and number of the first protruding member 155 and the second protruding member 156 are not limited. The first protruding member 155 is a symmetrically arranged structure so that the vibration-absorbing pad 150 and the locking member 140 can be evenly contacted and achieve vibration- absorbing effect. The second protruding member 156 is, for example, a symmetrically arranged structure, so that the vibration-absorbing pad 150 and the base 120 can be in uniform contact and achieve a vibration-absorbing effect. Since the fixing member 110, the base 120 and the locking member 140 are separated by the vibration-absorbing pad 150 to achieve a vibration-absorbing effect, the vibration of the color wheel module 100 can be effectively reduced.

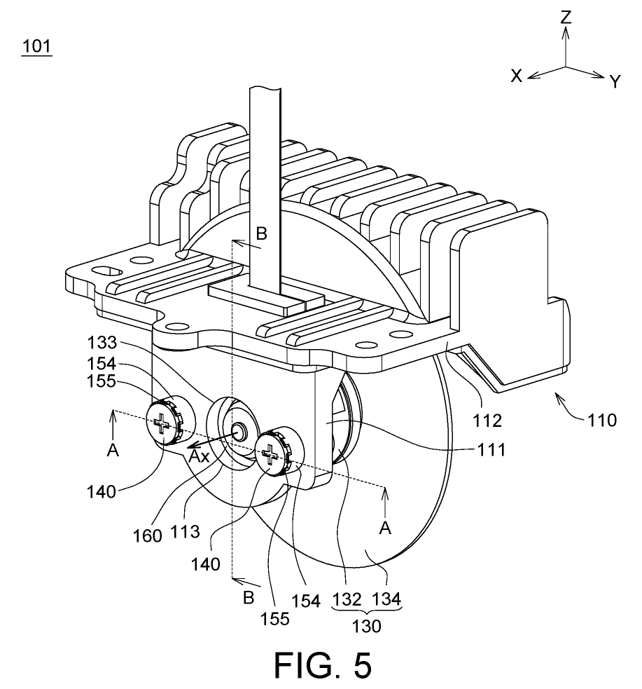

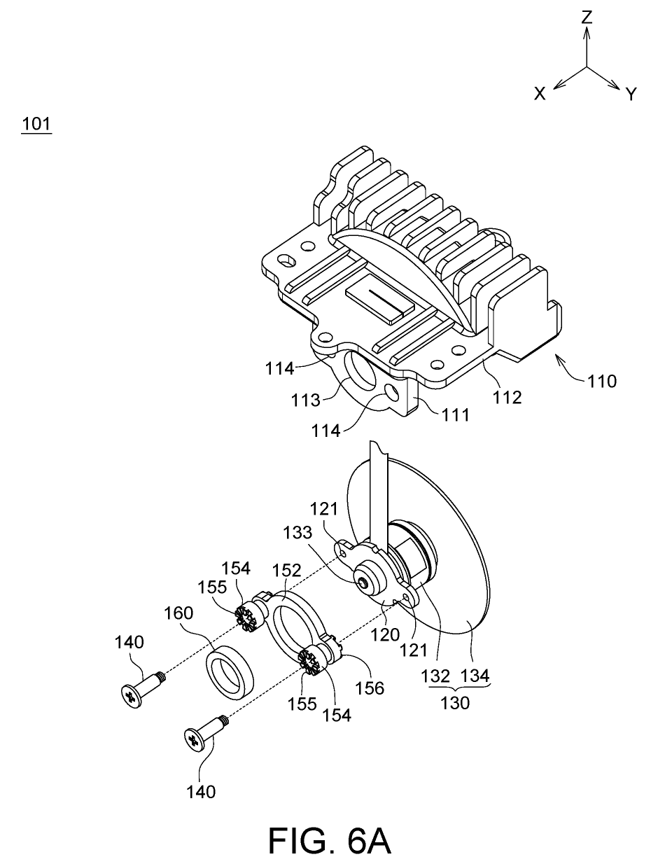

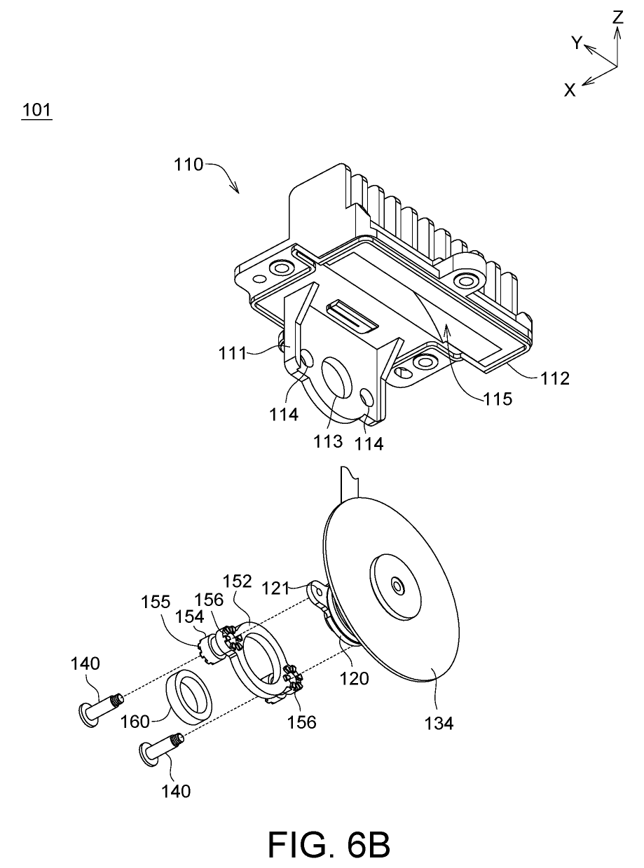

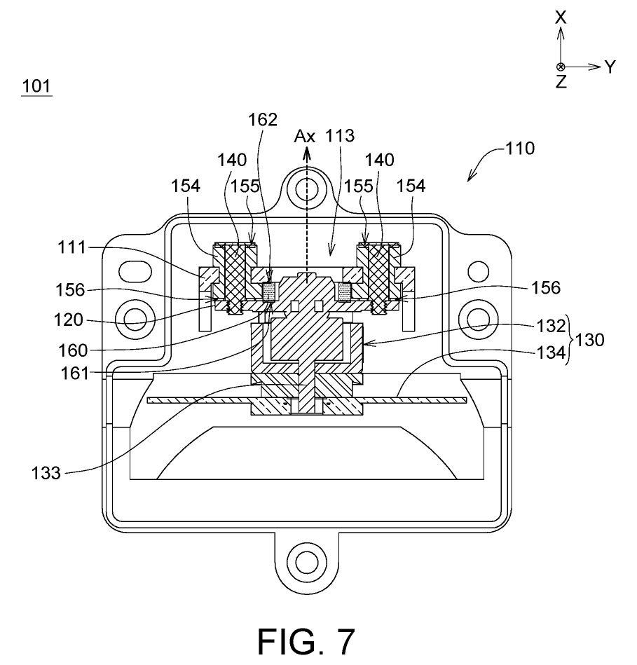

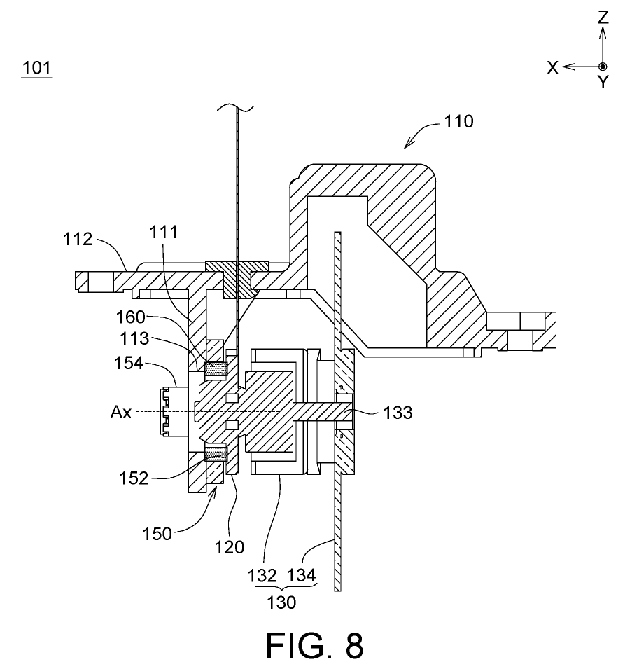

Referring to FIGS. 5 to 8, FIG. 5 is a three-dimensional view of a color wheel module 101 according to another embodiment of the present invention, and FIGS. 6A and 6B are exploded views of the color wheel module 101 of FIG. 5 at different angles. FIG. 7 is a schematic cross-sectional view of the color wheel module 101 of FIG. 5 along the line A-A, and FIG. 8 is a schematic cross-sectional view of the color wheel module 101 of FIG. 5 along the line B-B.

Although the accompanying drawings do not show the detailed internal structure of the projector, it is known to those skilled in the art that the color wheel module 101 of FIG. 5 can be applied to a digital micro-mirrors device (DMD) projection system. The detailed structure of the DMD projection system has been described in the above embodiments and will not be described herein.

Referring to FIG. 5, FIG. 6A and FIG. 6B, the color wheel module 101 includes a fixing member 110, a base 120, a moving part 130, a locking member 140 (two locking members 140 are illustrated as an example), a vibration-absorbing pad 150, and a heat dissipation pad 160. The detailed structures of the fixing member 110, the base 120, the moving part 130, the locking member 140 and the vibration-absorbing pad 150 have been described in the above embodiments, and will not be described herein.

The heat dissipation pad 160 is disposed on one side of the fixing member 110 corresponding to the base 120 (see FIGS. 7 and 8), that is, the heat dissipation pad 160 is located between the first bracket 111 and the base 120. In one embodiment, one end surface 161 of the heat dissipation pad 160 and the base 120 overlap and interfere with each other in the axial direction Ax, and the other end surface 162 of the heat dissipation pad 160 and the fixing member 110 (that is, the first bracket 111) overlap and interfere with each other in the axial direction Ax.

The heat dissipation pad 160 is, for example, an annular sheet (see FIG. 6A and FIG. 6B), which is disposed on the inner side of the vibration-absorbing pad 150, that is, disposed in the annular portion 152. The annular portion 152 surrounds the heat dissipation pad 160. However, the heat dissipation pad 160 may also be disposed at other positions and is not limited to being disposed in the annular portion 152.

The heat dissipation pad 160 can be made of a soft material, such as a silicone sheet or a silicon heat sink, which not only has a vibration-absorbing effect but also a thermal conduction effect. The heat dissipation pad 160 may form a thermal conduction path between the base 120 and the fixing member 110, so that waste heat generated by the moving part 130 such as the color wheel 134 may be transferred to the fixing member 110 via the heat dissipation pad 160. Since the fixing member 110 can be cast from a metal material, the fixing member 110 can transfer the waste heat to the outside of the color wheel module 101, so as to improve the heat dissipation capability of the color wheel module 101.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A color wheel module, comprising:
a fixing member, comprising an axial hole and a through hole;
a base and a moving part, the moving part is arranged on the base and rotates around an axial direction, the axial direction passes through the axial hole;
a locking member passing through the through hole, one end of the locking member is fixed to the base, and the base is fixed to the fixing member through the locking member; and
a vibration-absorbing pad arranged on one side of the fixing member relative to the base and in the through hole, and the vibration-absorbing pad separates the locking member from the corresponding fixing member and separates the fixing member from the corresponding base.

2. The color wheel module as claimed in claim 1, wherein the vibration-absorbing pad comprises an annular portion, and the annular portion is correspondingly located around the axial hole.

3. The color wheel module as claimed in claim 1, wherein a number of the through hole is two, the number of the locking member is two, and the two through holes are located on a center line passing through the axial hole.

4. The color wheel module as claimed in claim 2, wherein the annular portion comprises a protruding member, and the protruding member and the fixing member overlap and interfere with each other in the axial direction.

5. The color wheel module as claimed in claim 4, wherein the protruding member has symmetrically arranged structures.

6. The color wheel module as claimed in claim 4, wherein the protruding member is distributed on two opposite sides of the center line.

7. The color wheel module as claimed in claim 6, wherein the protruding member is orthogonally distributed relative to the center line.

8. The color wheel module as claimed in claim 6, wherein the protruding member is distributed in a mirror-imaged manner relative to the center line.

9. The color wheel module as claimed in claim 6, wherein the protruding member is distributed in an axisymmetric manner relative to the center line.

10. The color wheel module as claimed in claim 6, wherein the protruding member comprises a first protrusion, a second protrusion, a third protrusion and a fourth protrusion, a connection line between the first protrusion and the second protrusion passes through a center of the axial hole, and a connection line between the third protrusion and the fourth protrusion passes through the center of the axial hole.

11. The color wheel module as claimed in claim 6, wherein the protruding member are arranged in an asymmetrical structure relative to the center line.

12. The color wheel module as claimed in claim 11, wherein the protruding member is distributed on two opposite sides of the center line.

13. The color wheel module as claimed in claim 11, wherein the protruding member comprises a first protrusion and a second protrusion, and a connection line between the first protrusion and the second protrusion passes through a center of the axial hole, and the first protrusion and the second protrusion are distributed in a non-mirror-imaged manner relative to the center line.

14. The color wheel module as claimed in claim 2, wherein an area where the annular portion is vertically projected onto the fixing member at least partially overlaps an area where the base is vertically projected onto the fixing member.

15. The color wheel module as claimed in claim 1, wherein the vibration-absorbing pad comprises a covering portion, the covering portion is correspondingly located in the through hole, and the covering portion surrounds a periphery of the locking member.

16. The color wheel module as claimed in claim 15, wherein the covering portion is a hollow columnar structure, and two ends of the covering portion respectively have a first protruding member and a second protruding member, the first protruding member and the locking member overlap and interfere with each other in the axial direction, and the second protruding member and the base overlap and interfere with each other in the axial direction.

17. The color wheel module as claimed in claim 16, wherein the first protruding member has symmetrically arranged structures, and the second protruding member has symmetrically arranged structures.

18. The color wheel module as claimed in claim 1, further comprising a heat dissipation pad, the heat dissipation pad being disposed on one side of the fixing member corresponding to the base.

19. The color wheel module as claimed in claim 18, wherein one end surface of the heat dissipation pad and the base overlap and interfere with each other in the axial direction, and another end surface of the heat dissipation pad and the fixing member overlap and interfere with each other in the axial direction.

20. A projector comprising the color wheel module as claimed in claim 1.
